(19) United States
(12) Patent Application Publication
(10) Pub. No.: US 2008/0289236 A1
(43) Pub. Date: Nov. 27, 2008

(54) Portable multi-purpose weapon

(76) Inventor: Pierre Fischer, Geneva (CH)

Correspondence Address: WOLFF & SAMSON, P.C., ONE BOLAND DRIVE, WEST ORANGE, NJ, 07052, US

(21) Appl. No.: 12/012,414

(22) Filed: Feb. 1, 2008

Related U.S. Application Data
(60) Provisional application No. 60/994,227, filed on Sep. 18, 2007.

(30) Foreign Application Priority Data
Feb. 1, 2007 (DE) 10 2007 005 939.8

(51) Int. Cl. F41A 25/00; A41D 1/00; A41D 1/04; G01S 1/00

(52) U.S. Cl. 42/1.06; 42/111; 2/69; 2/102; 342/357.1

(57) ABSTRACT

A weapon system which may be carried by a person, including a weapon having a weapon barrel, a muzzle brake, a cartridge holder connected at a rear end of the barrel, a base part removably attached to the cartridge holder, and having a lock with an ignition device and a nozzle, a recoil brake mounted around the barrel, a weapon structure or weapon housing, a firing control operative to permit target assignment and an electrical communication interface between the person and the firing control.

This application claims priority from U.S. Provisional Application No. 60/994,227, filed Sep. 18, 2007, the entire contents of which are incorporated herein by reference.

### BACKGROUND OF THE INVENTION

In particular as the result of recent deployment missions of soldiers in peacekeeping areas, efforts have been made to design a weapon for soldiers that can be used for various purposes. The weapon should perform multiple functions and be usable for various objectives. There is also an increasing demand for such weapons which are suitable for nighttime use.

### SUMMARY OF THE INVENTION

Accordingly, the object of the present invention is to provide a weapon which ensures high effectiveness as well as mobility for the soldier/user.

The invention is based on the concept of providing a portable recoilless or low-recoil weapon or weapon system which is effective against stationary and mobile targets (daytime or nighttime), and which is able to fire a powerful programmable munition. The weapon system also has an independent firing control.

Although the weapon system is independent of the caliber, a caliber of 30 mm lends itself to the use of existing intelligent munitions, and the weight of such a weapon appears to be acceptable.

The weapon itself preferably comprises four main components: a barrel (having channels, for example), a muzzle brake with a programming unit, a cartridge holder having multiple gas openings which are opened by the initial motion of the projectile, and a base part, nozzle, lock, and ignition device. The cartridge holder and the base part may be separated, and allow loading of the projectile and removal of the empty shell. The cartridge shell is not bored for the gas opening so as not to interfere with ignition of the propellant. The gas opening is designed so that it is not opened prior to the motion of the projectile in the barrel.

The freedom from recoil is provided by the fact that the weapon has specialized devices which reduce the recoil force. A nozzle is thus used which in a known manner generates a counter-recoil force from a portion of the propellant gases. A muzzle brake having a highly efficient action is also incorporated. A recoil brake is additionally provided. In the gas expansion zone the nozzle has devices which, as the result of the gas dynamics, generate a torque which compensates for the rotational torque of the projectile through the channels.

The portability of the weapon is achieved, among other factors, by providing the barrel and muzzle brake materials in the form of a composite of metallic and nonmetallic materials. The capability for disassembling the weapon into its main components allows mobile transport by soldiers, for example in a case.

The modular design thus allows differentiated functions.

For this purpose a firing control is integrated into the portable weapon. Sensors are mounted in the weapon structure about the relevant axes. By means of these sensors and at least one computer (firing control), targets may be acquired and engaged in automatic mode or external mode. The sensors allow external target assignment and measurement of the sight line. A distance measuring device and an optical system are also integrated parallel to the firing axis.

The target image is preferably transmitted to a display screen on the weapon, and may be represented by a target mark. During tracking, the predicted target data are also extrapolated on a continuous basis, for example, enabling a “memo strike.”

Furthermore, a time limit is integrated into the weapon system which ensures that the predicted target data are not obsolete. For this purpose, for example, after this time elapses a repetition of the tracking phase is requested. It is definitely possible to specify this time limit on an individual or automatic basis. For safety reasons, however, this limit should not be entirely eliminated.

Here as well, the distance of the ejection point of the subprojectiles from the munition may be selected in a known manner as a function of the target. The projectile is preferably programmed automatically by the system, for which purpose the predicted target data and the variable ejection distance are taken into account by the processor.

The distance measuring device is operated with one of the two hands, so that the shot may be deployed by the free hand. Depending on the requirement, the weapon may be adapted for a left- or right-handed person.

The soldier generally wears a military vest and a helmet. In this case the processor, a radio set, and the power supply for the weapon system may be accommodated in the vest/jacket. The radio ensures communication between soldiers via data and speech transmission. A GPS device transforms the external target assignments into localized data. The data for programming the projectile, or also meteorological data, may be directly inputted via a weapon-mounted or mobile keyboard. The helmet is preferably equipped with an intercom, and is also preferably connected via a cable connection to a tactical display screen (possibly also directly on the weapon itself, or with the capability for communication with same).

This portable multi-purpose weapon may be used for land- and air-based threats. The weapon may engage hard or soft targets at specific or dispersed points, whereby the deployment distance to stationary targets may be selected to be greater than 2000 m, and for dynamic targets, up to 1000 m. The integration of a known night vision system (optical system) allows use in daytime and nighttime. Furthermore, of no small importance is the possibility for a networked system of portable weapon systems of the soldiers, whereby in particular the target data may be mutually coordinated and allowance may be made for the respective positions of the individual soldiers.

A 30-mm multi-purpose weapon, for example, of this design is thus able to replace an artillery gun, a grenade launcher (40-mm, for example), an anti-material rifle, an RPG 7, a 20-mm anti-aircraft cannon, and/or MANPADS.

Other features and advantages of the present invention will become apparent from the following description of the invention.

### BRIEF DESCRIPTION OF THE DRAWINGS

FIG. 1 shows a perspective illustration of the weapon system;

FIG. 2 shows a vest or the like associated with the weapon system;

FIG. 3 shows an illustration of the weapon as a component of the weapon system; and

FIG. 4 shows an enlarged illustration of the transition from the cartridge holder to the weapon barrel.

### DETAILED DESCRIPTION OF THE INVENTION

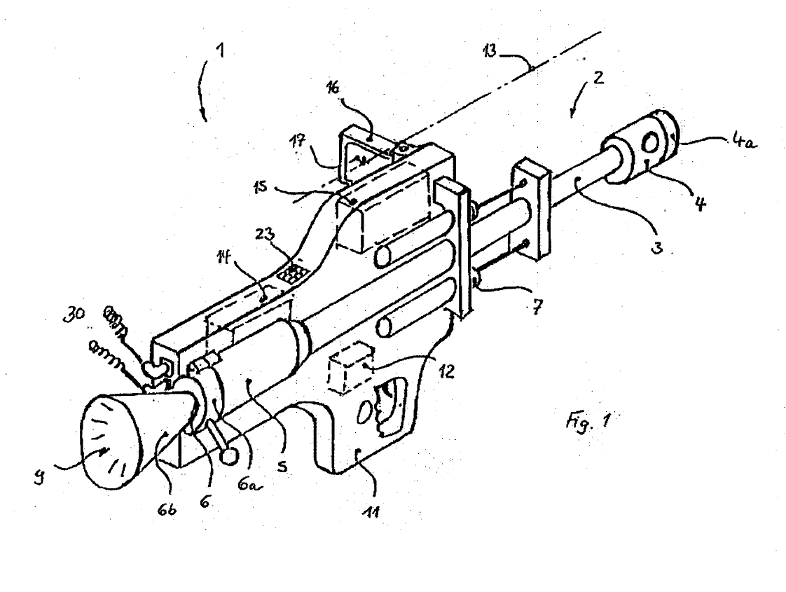

FIG. 1 partially illustrates a weapon system denoted by reference numeral 1, also functionally characterized as a weapon system that may be carried by a person, which may comprise a weapon 2 having a weapon barrel 3 and channels 3a, for example (FIG. 4), and a muzzle brake 4 with programming 4a, for example. Connected to the rear end of the weapon barrel 3 is a cartridge holder 5 together with a base part 6 and a lock with an ignition device 6a as well as a nozzle 6b. A recoil brake 7 is mounted around the weapon barrel 3. The recoil brake 7 together with the nozzle 6b and the high-efficiency muzzle brake 4 are used for reduction of the recoil force of the weapon 2.

The cartridge holder 5 preferably has multiple gas openings 8 (FIG. 4) which are opened by the initial motion of a projectile 10 (not illustrated in greater detail) during operation of the weapon system 1.

The cartridge holder 5 and the base part 6 can be separated so that the projectile 10 may be loaded into the cartridge holder 5 at this location.

In the gas expansion zone the nozzle 6b has devices 9 which, as the result of the gas dynamics, generate a torque that compensates for the rotational torque of the projectile 10 through the channels 3a.

Sensors 12 are mounted in the weapon structure 11 of the weapon system 1 about the relevant axes which allow external target assignment and measurement of the dynamics of the sight line 13. A distance measuring device 14 and/or an optical system 15 are preferably integrated parallel to the firing axis (barrel axis).

The target image may be transmitted to a foldable display screen 16 mounted on the weapon 2, and may be tracked with a target mark 17. The predicted target position may thus be represented on the display screen 16, for example by displacement of the target mark 17. The predicted target data are continuously extrapolated, thereby enabling a “memo strike.” In particular from the standpoint of accuracy, it should be ensured that the predicted target data do not become obsolete.

If the projectile 10 to be fired is an intelligent munition, the distance of the ejection point of the subprojectiles, for example, may be selected as a function of the target (scalable terminal energy and effect on the forget). The projectile is preferably programmed automatically. The predicted target data and the ejection distance, among other parameters, are computed by a system processor 18 and provided as data to the weapon 2 or to the projectile 10. Additional data may also programmed in externally, as

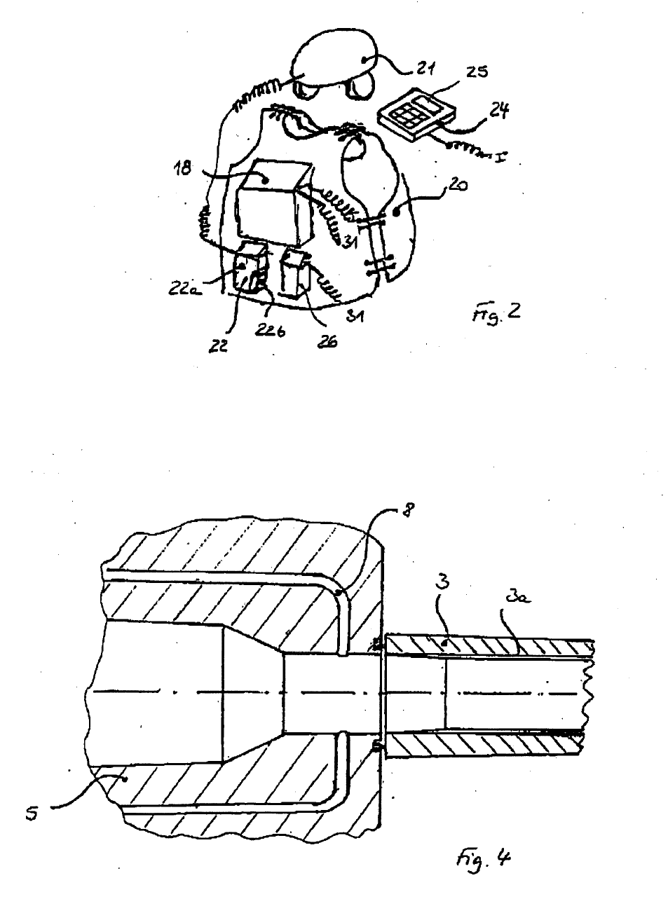

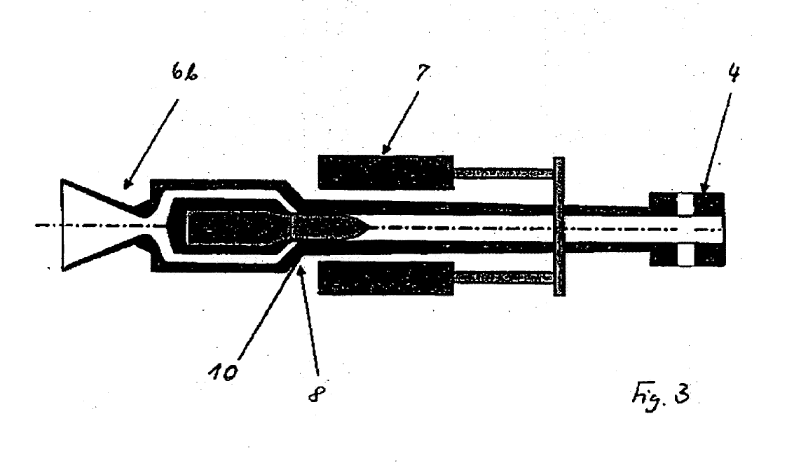

Besides the weapon 2, further components of the weapon system 1 are a vest 20 (or other article of clothing of the operator of the weapon system 1) and a helmet or type of head covering 21, as shown in FIG. 2. The processor 18 may then be integrated into the vest 20. In addition, a radio set 22 as well as the power supply 26 for the weapon system 1 are accommodated in the vest 20.

The radio set 22, in this case comprising a radio 22a and a GPS device 22b, ensures communication with the interconnected network, or is used to transform the external target assignment into localized data for the weapon system 1. The screen 16 by means of the optical system 15 displays motion direction commands for target acquisition.

The additional data for programming the projectile 10 or also the meteorological data may be directly inputted via a weapon-mounted keyboard 23 and/or mobile keyboard 24.

The helmet 21 may also be equipped with an intercom. A connection to a possible additional display screen 25 may be established via cable, or also without a cable. This display screen may also be integrated into the helmet 21.

It is understood that the electrical components of the weapon system 1 are interconnected in such a way that the supply 26 of current/voltage as well as functioning thereof within the weapon system 1 are ensured. To this end, all the electrical components are at least connected to one another by cable or the like.

An electrical communication interface 30, 31 connects the person using the weapon 2 and the firing control of the weapon. The communication interface can be integrated into the vest 20 and the helmet 21. The radio set 22 is also connected to the communication interface.

The weapon system can also be provided with a night vision system.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. A weapon system which may be carried by a person, comprising:
a weapon having a weapon barrel;
a muzzle brake;
a cartridge holder connected at a rear end of the barrel;
a base part removably attached to the cartridge holder, and having a lock with an ignition device and a nozzle;
a recoil brake mounted around the barrel;
a weapon structure or weapon housing;
a firing control operative to permit target assignment; and
an electrical communication interface between the person and the firing control.

2. The weapon system according to claim 1, wherein the firing control includes sensors provided on the weapon structure about relevant axes.

3. The weapon system according to claim 1, and further comprising a distance measuring device and an optical system mounted parallel to an axis of the barrel.

4. The weapon system according to claim 1, wherein the firing control includes a processor operative to compute predicted target data and an ejection distance of a projectile to be fired.

5. The weapon system according to claim 1, and further comprising a display screen mounted on the weapon structure for displaying a target image that can be tracked by a target mark.

6. The weapon system according to claim 1, and further comprising a weapon-mounted keyboard.

7. The weapon system according to claim 1, and further comprising an article of clothing and a head cover, the communication interface being integrated into the article of clothing and the head cover.

8. The weapon system according to claim 7, wherein the article of clothing is a vest and the headcover is a helmet.

9. The weapon system according to claim 1, and further comprising a radio set, including a radio and/or a GPS device, that is connected to the communication interface.

10. The weapon system according to claim 1, and further comprising a mobile keyboard and a display screen connected to the communication interface.

11. The weapon system according to claim 8, and further comprising a mobile power supply accommodated in or on the vest.

12. The weapon system according to claim 1, wherein the nozzle has devices in a gas expansion zone which generate a torque as a result of gas dynamics that compensates for rotational torque of the projectile through the barrel.

13. The weapon system according to claim 1, wherein the barrel and the muzzle brake are made of a composite of metallic and nonmetallic materials.

14. The weapon system according to claim 1, wherein the weapon system is configured to be disassemblable into main components so as to permit mobile transport.

15. The weapon system according to claim 1, and further comprising a night vision system.
